(19) United States
(12) Patent Application Publication
(10) Pub. No.: US 2017/0168805 A1
(43) Pub. Date: Jun. 15, 2017

(54) METHOD AND ELECTRONIC DEVICE FOR SYSTEM UPDATING

(71) Applicants: Le Holdings (Beijing) Co., Ltd., Beijing (CN); Lemobile Information Technology (Beijing) Co., Ltd., Beijing (CN)

(72) Inventor: Junkai Yin, Beijing (CN)

(21) Appl. No.: 15/249,665

(22) Filed: Aug. 29, 2016

Related U.S. Application Data
(63) Continuation of application No. PCT/CN2016/088357, filed on Jul. 4, 2016.

(30) Foreign Application Priority Data
Dec. 9, 2015 (CN) 201510906366.X

(51) Int. Cl. G06F 9/445; H04L 29/06; H04L 29/08; G06F 9/44

(52) U.S. Cl. CPC G06F 8/65; G06F 8/71; G06F 8/61; H04L 67/42; H04L 67/34; H04L 67/06; H04W 88/02

(57) ABSTRACT

The embodiments of the disclosure disclose a method for system updating of electronic device, the electronic device being in a screen locked state, wherein the method includes: receiving a system update message from a server end; reading the update type in the system update message; and, when the update type is an urgent or forced update, pushing system update information in a current lock screen application. With the embodiments of the disclosure, a user can be notified of system update information in time; even if the mobile phone is in a screen locked state, the user can still learn the system update information without unlocking the mobile phone, which greatly improves the system upgrade rate of mobile phones; moreover, a user can install an upgrade package updated by the system in time, ensuring that the mobile phone can play the best performance and make up system vulnerabilities in time.

### CROSS REFERENCE TO RELATED APPLICATIONS

This application is a continuation of International Application No. PCT/CN2016/088357 filed on Jul. 4, 2016, which claims priority to Chinese Patent Application No. 201510906366.X entitled “SYSTEM UPDATE METHOD AND DEVICE FOR SMART PHONE”, filed before the State Intellectual Property Office of China on Dec. 9, 2015, the entire contents of which are incorporated herein by reference.

### TECHNICAL FIELD

This disclosure relates to the information display technology of smart terminals, and specifically to a method and an electronic device for system updating of mobile phone.

### BACKGROUND

In existing technologies, when terminal equipment such as smart phone has a system update, a user generally needs to enter the system setting APP to see if there is a system update; if there is a system update, the user downloads an upgrade package and carries out the system update. However, in this condition, many users do not examine actively whether there is a system update. Thus, the upgrade rate of system is relatively low, and the mobile phones of the users may also have safety vulnerabilities or cannot play the optimal system functions for they are not installed with the latest system updates.

There is a system update method proposed to notify a user when the user powers on and uses a mobile phone if the system has an important update, in which the user enters the system setting APP to carry upgrade after seeing the notification; although this upgrade method can prompt a user in time to carry out upgrade, the user still needs to enter the system setting APP to carry out upgrade and must carry out upgrade in the condition that the mobile phone is powered on and is in use; if the mobile phone of a user is in a screen locked state, the mobile phone cannot receive the information about a system update.

Therefore, it is necessary to provide a new system update method for a smart phone so as to solve the above problems.

### SUMMARY

In view of the drawbacks of the existing technologies, the purpose of the embodiments of the disclosure is to provide a method and an electronic device for system updating of smart phone, which can notify a user of system update information in time and can still provide the system update information to the user even if in a screen locked state of a mobile phone.

The embodiments of the disclosure provide a method for system updating of electronic device, including: when the electronic device is in a screen locked state: receiving a system update message from a server end; reading the update type in the system update message; and pushing system update information in a current lock screen application when the update type is an urgent or forced update.

The embodiments of the disclosure provide a non-transitory computer storage media having computer executable instructions stored thereon, wherein the computer executable instructions can be executed by at least one processor of the electronic device, such that the at least one processor is able to receive a system update message from a server end; to read the update type in the system update message; to push system update information in a current lock screen application when the update type is an urgent or forced update.

The embodiments of the disclosure further provide an electronic device, including: one or more processors; and a memory communicably connected with the one or more processors; wherein the memory is stored with instructions executable by the one or more processors, the instructions are configured to receive a system update message from a server end; to read the update type in the system update message; to push system update information in a current lock screen application when the update type is an urgent or forced update.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise.

FIG. 1 is a flowchart of a system update method for a mobile phone in a specific embodiment of this disclosure.

FIG. 2 is a system structure diagram of a system update device for a mobile phone in a specific embodiment of this disclosure.

FIG. 3A is a screen capture of displaying an update prompt in a screen locked state of a mobile phone in an embodiment of this disclosure.

FIG. 3B is a screen capture of displaying an update prompt in a screen locked state of a mobile phone after a user's finger swipes up in an embodiment of this disclosure.

FIG. 3C is a screen capture of displaying all update prompts in a screen locked state of a mobile phone after a user' s finger continues to swipe up in FIG. 3B.

FIG. 4 is a schematic diagram of a structure of an hardware of the device of the method for system updating of smart phone according to an embodiment of the disclosure.

### DESCRIPTION OF THE EMBODIMENTS

In this embodiment of the disclosure, if a server end sends a prompt message about an urgent system update to a phone terminal, when the phone terminal of a user receives the message, the phone in a screen locked state may display the update information in time; after the user learns the display of the update information, he/she may read the update notification and then download and install the package of the information update.

This embodiment of the disclosure may be applied to the system update upgrade of smart phones; however, those skilled in the art should understand that other smart mobile devices, such a PAD, smart television and the like, may also adopt the technical scheme of this disclosure.

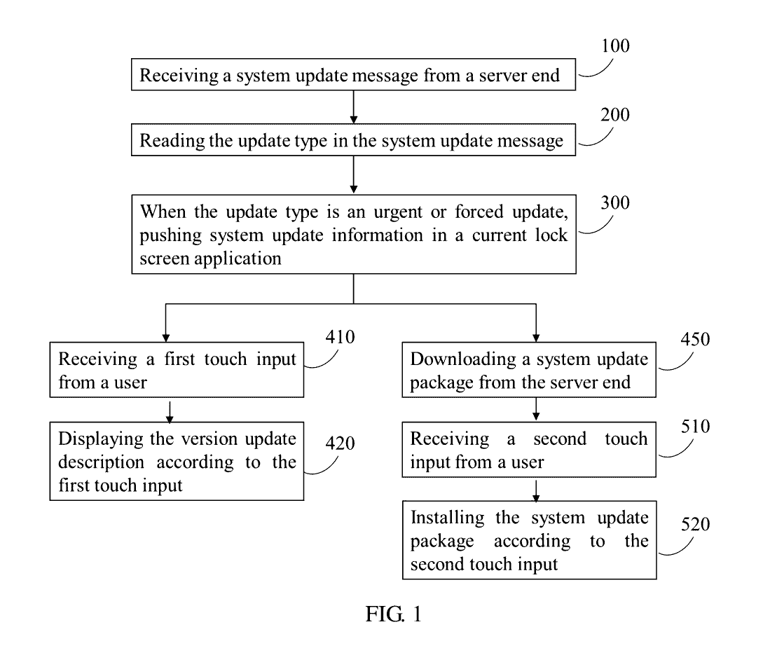

FIG. 1 is a flowchart of a system update method for a mobile phone in a specific embodiment of this disclosure. In this embodiment, the mobile phone is in a screen locked state. Lock screen refers to an application which temporarily shields screen input without shutting down system software. As shown in FIG. 1, the specific embodiment includes the following steps:

S100: receiving a system update message from a server end. The system update is initiated by a server; after the operating system of a mobile phone is found to have a vulnerability or functions thereof are further optimized, a corresponding developed upgrade package is stored in the server, which then sends a system update message to the mobile phone of a user; the format of the system update message may be sent through an appropriate data transfer protocol, such as SMS, MMS and the like. The update message may include a server address, the type of the system update information and other data. Correspondingly, the system update message may be received at a phone terminal of a user.

S200: reading the update type in the system update message. The system update message includes the data of the system update type; the system update type may be one of an ordinary update, an urgent update and a forced update. Different types indicate the urgency degree and importance degree of different system updates. For example, the ordinary type of system update indicates an update with a medium importance degree, which may be upgraded by the user at idle time; the urgent type indicates that the system update is an important update and the user should install the upgrade package as soon as possible; the forced update type indicates that the system has a big vulnerability and security risk and the user must carry out upgrade the first time.

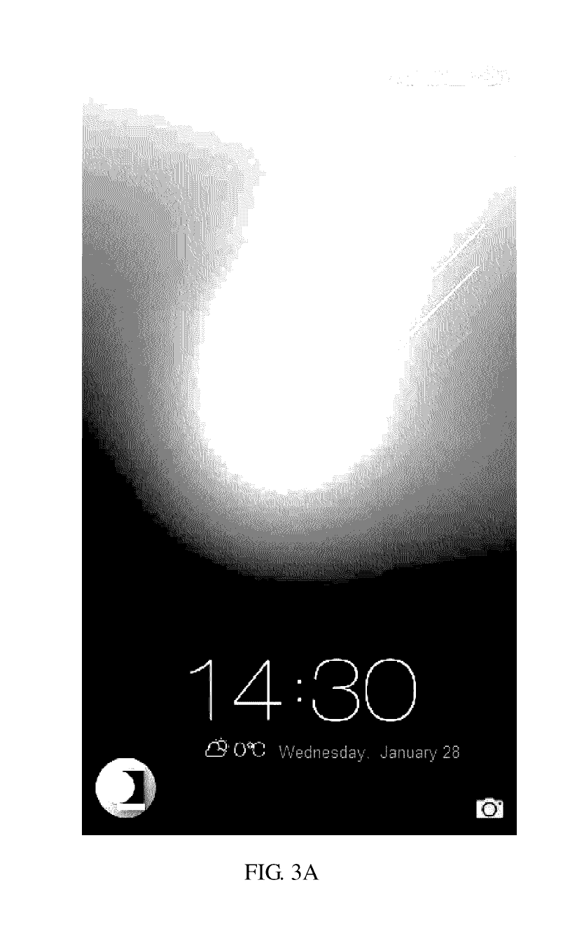

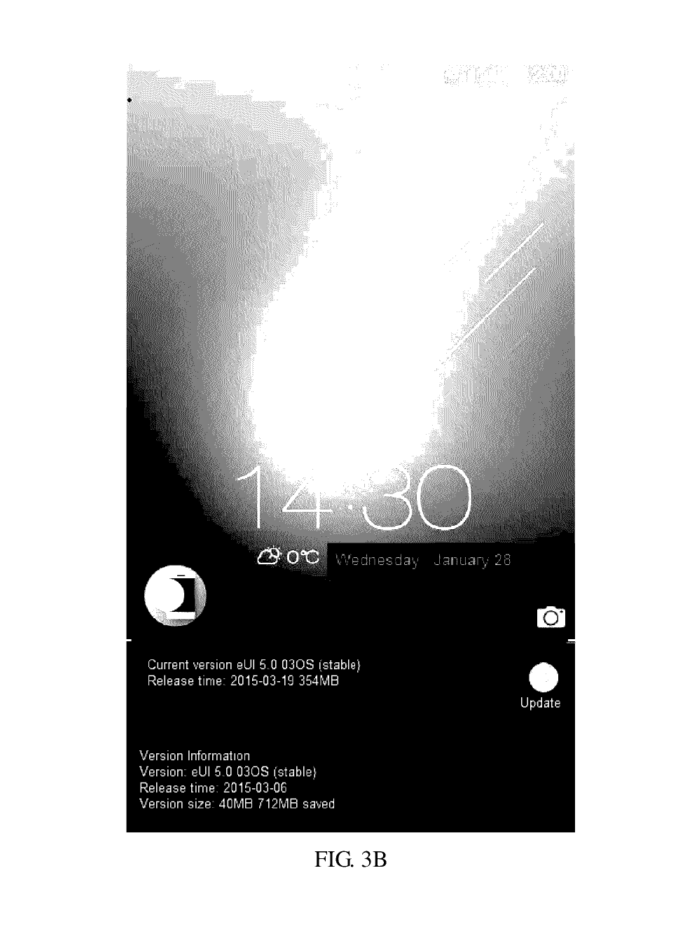

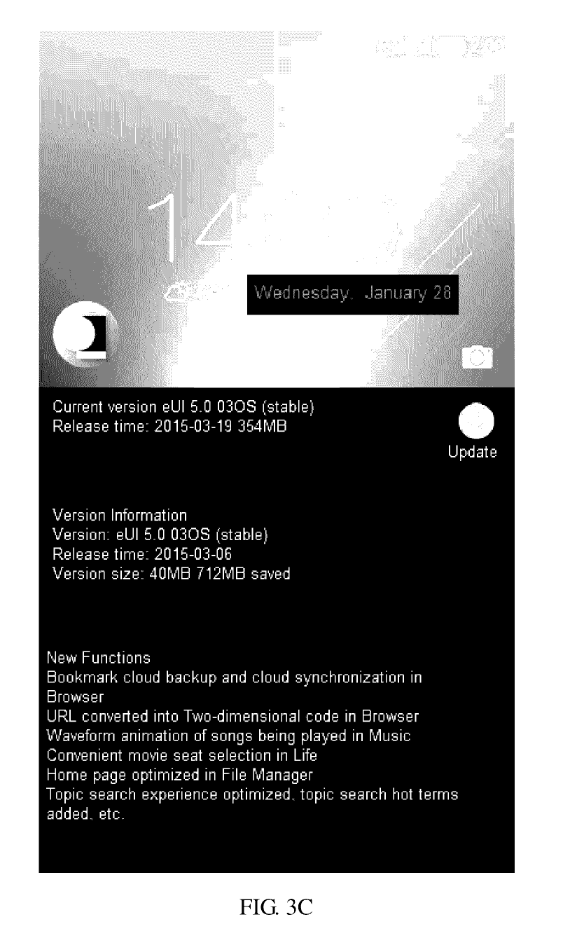

S300: when the update type is an urgent or forced update, pushing system update information in a current lock screen application. After the judgment of update type in S200, if the update type is an urgent or forced update, the system update information is pushed in the current lock screen application. In particular, since lock screen itself is an application (APP), it is judged first whether the lock screen is already running during specific implementation steps; the method for judgment may acquire the current screen state by receiving a broadcast of the Android system, the system sending a broadcast when the screen switches among the screen started state, the screen locked state and the screen unlocked state, for example, acquiring the screen state by the method of intent.get Action ( ). In the screen locked state, although the screen does not display a normal startup desktop, the screen still has a function of displaying corresponding message notifications; therefore, in this step, the system update information to be pushed to a user is sent to the notification bar on the lock screen interface. As shown in FIG. 3A, in this embodiment, the left bottom in the screen locked state is the notification bar of the lock screen interface, and the circular icon is a prompt of system update information.

In an optional embodiment, the priority of the system update information is a type of forced interruption. In particular, the prompt may also display other notification information, however, when the update type is an urgent or forced update, the priority of the system update information is higher than the priority of other notifications, that is, once a notification of system update information is received, the notification of the system update information covers other notifications and is always at the top in the icon at the left bottom shown in FIG. 3A, to prompt a user persistently.

In an optional embodiment, the system update information not only includes a system update prompt, but also includes a version update description. The version update description includes version information and function introduction; after responding to a corresponding touch input from a user, system update information including the version update description is displayed on the lock screen interface of the mobile phone. For example, after S300, the method further includes S400, S400 including:

S410: receiving a first touch input from a user. FIG. 3A is a screen capture of displaying an update prompt in the screen locked state of a mobile phone in an embodiment of this disclosure. FIG. 3B is a screen capture of displaying an update prompt in the screen locked state of a mobile phone after a user's finger swipes up in an embodiment of this disclosure. The first touch input may be a touch signal input by a user to a touch screen through a finger or a device such as stylus. As shown in FIG. 3A and FIG. 3B, after a user clicks the circular icon at the left bottom shown in FIG. 3A, FIG. 3B displays the version number and version information of the current update. If the first touch input of the user is to click the circular button and swipe up, the version update description is displayed according to the first touch input at S420 as shown in FIG. 3C, the version update description further including the function description of the system update.

In an optional embodiment, the method may further include S450: downloading a system update package from the server end. Through the above steps, the user already learns the content of the system update through the update information pushed in the screen locked state, and then the phone terminal of the user may further interact with the server end and download the package of the system update from the server. During the whole process of downloading the package, the mobile phone of the user is still in a screen locked state; the process of downloading the package is running at background, the downloaded package is stored in a memory of the smart phone, and upgrade installation is carried out after the user inputs a touch action for confirming installation. For example, the method may further include S500 after S300, S500 further including:

after downloading the system update package, receiving a second touch input from a user at S510; the second touch input, similar to the above first touch input, may be a touch signal input by a user to a touch screen through a finger or a device such as stylus, wherein the touch action may be clicking, sliding and other gesture actions. The lock screen interface may display a prompt similar to “Download Update” (not shown in this disclosure), and the user may input a response click or other forms of second touch input to respond to the prompt.

S520: installing the system update package according to the second touch input. During the process of downloading the system update package, the phone terminal is still in a screen locked state; the process of downloading the system update package is running at background, the downloaded package is stored in a memory of the smart phone, and the system update package may be installed after a further confirmation is obtained from the user.

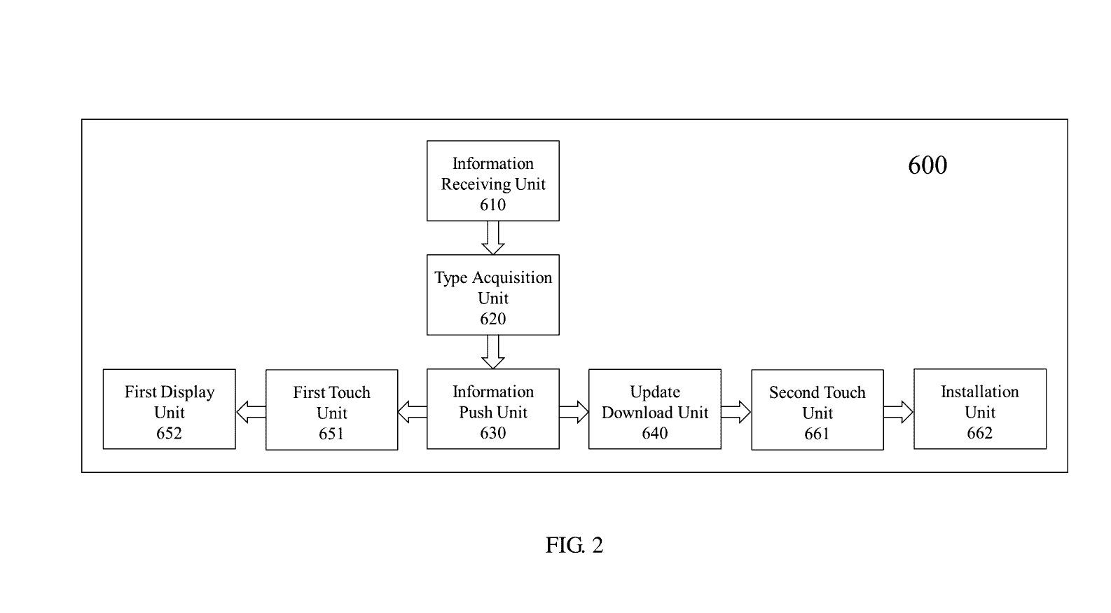

Correspondingly, the embodiments of the disclosure further provide a system update device 600 for a smart phone, the smart phone being in a screen locked state. FIG. 2 is a system structure diagram of a system update device for a mobile phone in a specific embodiment of this disclosure. As shown in FIG. 2, the device includes: an information receiving unit 610, a type acquisition unit 620 and an information push unit 630, wherein

the information receiving unit 610 receives a system update message from a server end. A server sends a system update message to a mobile phone of a user; the format of the system update message may be sent through an appropriate data transfer protocol, such as SMS, MMS and the like. The update message may include a server address, the type of the system update information and other data. The information receiving unit 610 may be realized through a data receiving port and corresponding protocol resolution.

The type acquisition unit 620 reads the update type in the system update message. The system update type may be one of an ordinary update, an urgent update and a forced update. Different types indicate the urgency degree and importance degree of different system updates. The type acquisition unit 620 may read the type identification in the system update message, thereby judging the update type.

The information push unit 630 pushes system update information in a current lock screen application when the update type is an urgent or forced update

The system update information includes a version update description. The version update description may include version information and function introduction.

In an optional embodiment, the system update device 600 further includes a first touch unit 651 and a first display unit 652, wherein the first touch unit 651 is configured to receive a first touch input from a user, the first touch unit 651 is configured to receive a touch signal input by a user to a touch screen through a finger or a device such as stylus. The first display unit 652 is configured to display the version update description according to the first touch input. In particular, the first display unit 652 is configured to display the version update description at a specific region of the mobile phone screen. The first touch unit 651 and the first display unit 652 are realized through a mobile phone touch screen and corresponding software modules.

The system update device 600 may further include an update download unit 640, which is configured to download a system update package from the server end. The downloading process of the update download unit 640 is running at background, and the downloaded package is stored in a memory of the smart phone. The update download unit 640 may be realized through a download program in the system APP. In an optional embodiment, after downloading the system update package, the system update device 600 includes a second touch unit 661 and an installation unit 662, wherein the second touch unit 661 is configured to receive a second touch input from a user; and the installation unit 662 is configured to install the system update package according to the second touch input. The second touch unit 661 is realized through a mobile phone touch screen and corresponding software modules; and the installation unit 662 may be realized through an installation program in the system APP.

In an optional embodiment, the priority of the system update information is a type of forced interruption, that is, as notification information, the system update information has a priority higher than that of other ordinary notification messages, and is displayed on the lock screen interface preferentially.

In a specific embodiment, as shown in FIG. 3A to FIG. 3C, the specific process of a user viewing system update information using the system update method for a mobile phone provided in this embodiment of the disclosure is as follows:

1. As shown in FIG. 3A, when a mobile phone receives the push of an urgent or forced update, the lock screen immediately displays a system update information prompt obviously in the circular button type icon at the left bottom thereof.

2. A user clicks the circular button and swipes up using a finger, so as to call out the system update information interface, the update information including: pushed version number, version information, update description of the version and so on.

3. This update belongs to the type of forced interruption, that is, if other notification information has been displayed in the circular button before, this system update will cover the previous notifications, then, the previous notifications are not displayed anymore and only this system update information is displayed.

An embodiment of the disclosure provides a non-transitory computer storage media having computer executable instructions stored thereon, wherein the computer executable instructions can perform any one of the methods for system updating of smart phone in the foregoing embodiments of methods.

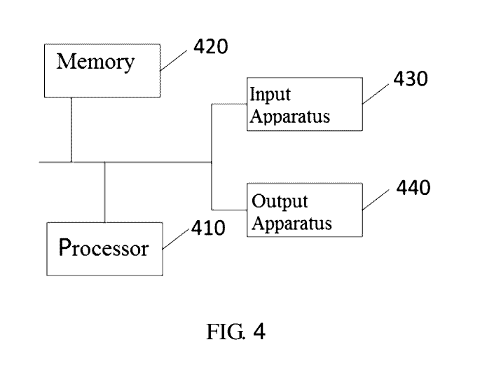

FIG. 4 is a schematic diagram of a structure of an hardware of the device of the method for system updating of smart phone according to an embodiment of the disclosure, as shown in FIG. 4, this device includes:

one or more processors 410 and a memory 420, in FIG. 4, one processor 410 is employed as an example.

The device which executes the method for system updating of smart phone may further comprise: an input apparatus 430 and an output apparatus 440.

The processor 410, the memory 420, the input apparatus 430 and the output apparatus 440 may be connected via a bus or other means, in FIG. 4, a connection via a bus is taken as an example.

As a non-transitory computer readable storage media, the memory 420 can be used to store non-transitory software program, non-transitory computer executable program and module, such as the program instructions/modules corresponding to the method for system updating of smart phone in the embodiments of the present application (e.g., the information receiving unit 610, a type acquisition unit 620, an information push unit 630, and the update download unit 640 as shown in FIG. 2). The processor 410 executes various functions and applications of a server and data processing by running a non-transitory software program, instructions and a module stored in the memory 420, so as to carry out the method for system updating of smart phone in the embodiments above.

The memory 420 may include a program storage area and a data storage area, wherein the program storage area can store an operating system, an application program required for at least one function; the data storage area can store the data created based on the use of the device for system updating of smart phone, or the like. Further, the memory 420 may include high-speed random access memory, and may further include non-transitory memory, such as at least one disk storage device, flash memory device, or other non-transitory solid-state memory devices. In some embodiments, the memory 420 optionally includes a memory remotely located with respect to the processor 410, which may be connected to an device for system updating of smart phone via a network. Examples of such network include, but not limited to, Internet, Intranet, local area network (LAN), mobile communication network, and combinations thereof.

The input apparatus 430 may receive the input numbers or characters information, as well as key signal input associated with user settings of the device for system updating of smart phone and function control. The output apparatus 440 may include a display screen or other display device.

The one or more modules are stored in the memory 420, and when being executed by the one or more processors 410, execute the method for system updating of smart phone according to the above embodiments of method.

The above mentioned products can perform the method provided by the embodiments of the present application, and they have the function modules and beneficial effects corresponding to this method. With respect to the technical details that are not detailed in this embodiment, please refer to the methods provided by the embodiments of the present application.

The electronic device according to the embodiments of the present application may have many forms, for example, including, but not limited to:

(1) mobile communication device: the characteristic of such device is: it has the function of mobile communication, and takes providing voice and data communications as the main target. Such type of terminal includes: smart phones (for example iPhone), multimedia phones, feature phones and low-end mobile phones.

(2) ultra mobile PC device: this type of device belongs to the category of personal computer, it has the capabilities of computing and processing, and generally has the feature of mobile Internet access. Such type of terminal includes: PDA, MID and UMPC devices.

(3) portable entertainment device: this type of device can display and play multimedia content. Such type of device includes: audio players (for example iPod), video players, handheld game consoles, e-books, as well as smart toys and portable vehicle navigation devices.

(4) server: it provides computing services, and the structure of the server includes: a processor, a hard disk, a memory, a system bus and the like, its construction is similar to a general computer, but there is higher requirement on the processing capability, stability, reliability, security, scalability, manageability and other aspects of the server as highly reliable service is needed to provide.

(5) other electronic device that has the function of data exchange.

The apparatus of the above described embodiments are merely illustrative, and the unit described as separating member may or may not be physically separated, the component shown as a unit may be or may not be a physical unit, i.e., it may be located at one place, or it can be distributed to a plurality of network units. The aim of this embodiment can be implemented by selecting a part of or all of the modules according to the practical needs. And it can be understood and implemented by those of ordinary skill in the art without paying any creative work.

With reference to the above described embodiments, those skilled in the art can clearly understand that all the embodiments may be implemented by means of using software plus a necessary universal hardware platform, of course, they also be implemented by hardware. Based on this understanding, the above technical solution can be substantially, or the part thereof contributing to the prior art may be, embodied in the form of a software product, and the computer software product may be stored in a computer readable storage medium, such as ROM/RAM, magnetic disc, CD-ROM, or the like, which includes several instructions to instruct a computer device (may be a personal computer, server, or network equipment) to perform the method described in each embodiment or some parts of the embodiment.

Finally, it should be noted that: the above embodiments are merely provided for describing the technical solutions of the present invention, but not intended to limit thereto; although the present invention has been described in detail with reference to the foregoing embodiments, those skilled in the art will appreciate that: they can make modifications to the technical solutions described in the foregoing embodiments, or make equivalent replacements to some technical features thereof; and these modifications or replacements do not make the essence of corresponding technical solutions depart from the spirit and scope of the technical solution of each embodiment.

What is claimed is:

1. A method for system updating of electronic device, comprising:
when the electronic device is in a screen locked state:
receiving a system update message from a server end;
reading the update type in the system update message; and
when the update type is an urgent or forced update, pushing system update information in a current lock screen application.

2. The method according to claim 1, wherein the method further comprises: downloading a system update package from the server end.

3. The method according to claim 1, wherein the system update information comprises a version update description.

4. The method according to claim 3, wherein after pushing system update information in a current lock screen application, the method further comprises:
receiving a first touch input from a user; and
displaying the version update description according to the first touch input.

5. The method according to claim 3, wherein, after pushing system update information in a current lock screen application, the method further comprises:
receiving a second touch input from a user; and
installing the system update package according to the second touch input.

6. The method according to claim 5, wherein the priority of the system update information is a type of forced interruption.

7. A non-transitory computer storage media having computer executable instructions stored thereon, wherein the computer executable instructions can be executed by at least one processor of the electronic device, such that the at least one processor is capable of:
receiving a system update message from a server end;
reading the update type in the system update message; and
when the update type is an urgent or forced update, pushing system update information in a current lock screen application.

8. The non-transitory computer storage media according to claim 7, wherein the computer executable instructions further are configured to apply the at least one processor to be capable of:
downloading a system update package from the server end.

9. The non-transitory computer storage media according to claim 7, wherein the system update information comprises a version update description.

10. The non-transitory computer storage media according to claim 9, wherein the computer executable instructions further are configured to apply the at least one processor to be capable of:
receiving a first touch input from a user; and
displaying the version update description according to the first touch input.

11. The non-transitory computer storage media according to claim 9, wherein the computer executable instructions further are configured to apply the at least one processor to be capable of:
receiving a second touch input from a user; and
installing the system update package according to the second touch input.

12. The non-transitory computer storage media according to claim 11, wherein the priority of the system update information is a type of forced interruption.

13. An electronic device, comprising:
one or more processors; and
a memory communicably connected with the one or more processors; wherein, the memory is stored with instructions executable by the one or more processors, wherein the instructions can be executed by one or more processor of the electronic device, such that the one or more processor is capable of:
receiving a system update message from a server end;
reading the update type in the system update message; and
when the update type is an urgent or forced update, pushing system update information in a current lock screen application.

14. The electronic device according to claim 13, wherein the instructions further are configured to apply the at least one processor to be capable of:
downloading a system update package from the server end.

15. The electronic device according to claim 13, wherein the system update information comprises a version update description.

16. The electronic device according to claim 13, wherein the instructions further are configured to apply the at least one processor to be capable of:
receiving a first touch input from a user; and
displaying the version update description according to the first touch input.

17. The electronic device according to claim 15, wherein the instructions further are configured to apply the at least one processor to be capable of:
receiving a second touch input from a user; and
installing the system update package according to the second touch input.

18. The electronic device according to claim 17, wherein the priority of the system update information is a type of forced interruption.
